(19) United States
(12) Patent Application Publication
(10) Pub. No.: US 2017/0351813 A1
(43) Pub. Date: Dec. 7, 2017

(54) CROSS-PLATFORM HEALTH INFORMATION MANAGEMENT SYSTEM

(71) Applicant: Strength Master Fitness Tech. Co., Ltd, Changhua County (TW)

(72) Inventors: Ming-Chu Su, Changhua County (TW); Shu-Yao Wu, Changhua County (TW)

(73) Assignee: Strength Master Fitness Tech. Co., Ltd

(21) Appl. No.: 15/171,614

(22) Filed: Jun. 2, 2016

(51) Int. Cl. G06F 19/00

(52) U.S. Cl. CPC G06F 19/322; G06F 19/3425

(57) ABSTRACT

A cross-platform health information management system is provided, including a cross-platform module and a cloud server. The cross-platform module is adapted to a first operating system and a second operating system, which are different operating systems. The cross-platform module is installed in a first device including the first operating system, and connects to a first health management platform disposed in the first device to transmit first health information. Alternatively, the cross-platform module is installed in a second device including the second operating system, and connects to a second health management platform disposed in the second device to transmit second health information. The cloud server connects to the cross-platform module, and transmits and stores the first health information or the second health information.

### BACKGROUND OF THE INVENTION

### 1. Field of the Invention

This application relates to a health information management system, and in particular, to a cross-platform health information management system designed to collect health information from different systems and then to integrate and store the collected health information.

### 2. Description of the Related Art

With the development of medical treatment, people care about their health more than ever. Besides, the emergence of various portable and user-friendly apparatus that can measure one's health status, such as wearable devices and exercise equipment, allows us to examine our personal physical condition while exercising indoors or outdoors. As a consequence, going to regular physical checkups at hospitals or local clinics is no longer quite as necessary as before. The health information recorded with the apparatus is usually transmitted to smart devices such as smartphones, tablets, and others.

However, current smart devices use different operating systems or application programming interfaces (APIs), which are incompatible when it comes to sharing health information. For instance, if the user uses a new phone, the health information stored in the original phone cannot be accessed with the new phone. Also, when the user has more than one smart device, it is hard to manage the health information stored in two or more different devices effectively. In order to address such issues, the present disclosure provides a cross-platform health information management system adapted to collect health information from different operating systems and then to integrate and store the collected health information so as to improve usability.

### SUMMARY OF THE INVENTION

In view of the aforementioned technical problems, the objective of the present disclosure is to provide a cross-platform health information management system designed to collect health information from different operating systems and then to integrate and store the collected health information.

In accordance with the objective mentioned above, a cross-platform health information management system is provided, including a cross-platform module and a cloud server. The cross-platform module is adapted to a first operating system and to a second operating system which are different operating systems. The cross-platform module is installed in a first device including the first operating system, and connects to a first health management platform, which is disposed in the first device, so as to transmit first health information. Alternatively, the cross-platform module is installed in a second device including the second operating system, and connects to a second health management platform, which is disposed in the second device, so as to transmit second health information. The cross-platform module connects to the cloud server to transmit the first health information in the cross-platform module of the first device or to transmit the second health information in the cross-platform module of the second device. The cloud server stores the first health information or the second health information.

Preferably, the cross-platform module connects to a health information collecting device. The health information collecting device transmits original information to the cross-platform module. The cross-platform module transforms the original information into the first health information.

Preferably, the first device comprises an application program which connects to the health information collecting device. The health information collecting device transmits the original information to the application program. The first health management platform connects to the application program to receive the original information and then transforms the original information into the first health information.

Preferably, the cloud server integrates the first health information and the second health information producing integrated information and then stores the integrated information. The cross-platform module disposed in the first device reads the integrated information stored in the cloud server and then transmits the integrated information to the first health management platform.

Preferably, the cloud server comprises a defined application programming interface (API) configured to connect to the cross-platform module and to transmit the first health information or the second health information.

In accordance with the objective mentioned above, an alternative cross-platform health information management system is provided, including a first health information collecting device, a cross-platform module and a cloud server. The first health information collecting device is connected to a first device including a first operating system, or is connected to a second device including a second operating system, wherein the first operating system and the second operating system are different operating systems. The cross-platform module is adapted to the first operating system and the second operating system. The cross-platform module is provided by the first health information collecting device, and is installed in the first device, and connects to a first health management platform disposed in the first device so as to transmit the first health information. Alternatively, the cross-platform module is provided by the first health information collecting device, and is installed in the second device, and connects to a second health management platform disposed in second device so as to transmit second health information. The cross-platform module connects to the cloud server to transmit the first health information in the cross-platform module of the first device or to transmit the second health information in the cross-platform module of the second device. The cloud server stores the first health information or the second health information.

Preferably, the health information collecting device produces first original information and connects to the cross-platform module to transmit the first original information to the cross-platform module. The cross-platform module transforms the first original information into the first health information.

Preferably, the first device comprises an application program which connects to the health information collecting device. The health information collecting device transmits the original information to the application program. The first health management platform connects to the application program to receive the original information and then transforms the original information into the first health information.

In accordance with the objective mentioned above, a further alternative cross-platform health information management system is provided, including a first device, a second device, a cross-platform module and a cloud server. The first device includes a first operating system and a first health management platform. The first health management platform has first health information. The second device includes a second operating system which is different from the first operating system and a second health management platform. The second health management platform has second health information. The cross-platform is installed in both the first device and the second device and adapted thereto. The cross-platform module connects to the first health management platform to transmit the first health information and also connects to the second health management platform to transmit the second health information. The cross-platform module connects to the cloud server. The cloud server transmits and stores the first health information and the second health information.

Preferably, the cloud server integrates the first health information and the second health information producing integrated information and then stores the integrated information. The cross-platform module disposed in the first device reads the integrated information stored in the cloud server and then transmits the integrated information to the first health management platform.

In conclusion, the cross-platform health information management system provided by the present disclosure uses a cross-platform module, which is adapted to different operating systems, to retrieve health information from different devices and then transmits the obtained health information to the cloud server for storage. In this way, the cross-platform module can effectively manage the health information across different operating systems.

### BRIEF DESCRIPTION OF THE DRAWINGS

FIG. 1 is a block diagram of the first embodiment of a cross-platform health information management system in accordance with the present disclosure.

FIG. 2 is a block diagram of the second embodiment of a cross-platform health information management system in accordance with the present disclosure.

FIG. 3 is a block diagram of the third embodiment of a cross-platform health information management system in accordance with the present disclosure.

FIG. 4 is a block diagram of the fourth embodiment of a cross-platform health information management system in accordance with the present disclosure.

FIG. 5 is a block diagram of the fifth embodiment of a cross-platform health information management system in accordance with the present disclosure.

FIG. 6 is a block diagram of the sixth embodiment of a cross-platform health information management system in accordance with the present disclosure.

FIG. 7 is a schematic of a cross-platform health information management system in accordance with the present disclosure.

### DETAILED DESCRIPTION OF THE PREFERRED EMBODIMENTS

Hereinafter, embodiments of the present disclosure will be described in detail with reference to the accompanying drawings so that those skilled in the art to which the present invention pertains can realize the present disclosure. As those skilled in the art would realize, the described embodiments may be modified in various different ways, all without departing from the spirit or scope of the present invention.

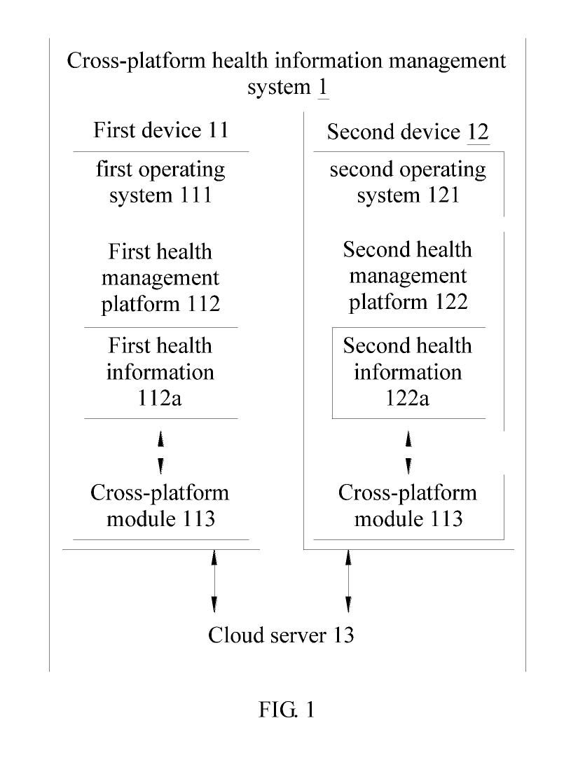

Please refer to FIG. 1, which is a block diagram of the first embodiment of a cross-platform health information management system in accordance with the present disclosure. As shown in the figure, the cross-platform health information management system 1, a selected embodiment provided in the present disclosure, includes a cross-platform module 113 and a cloud server.

The cross-platform module 113 is adapted to a first operating system 111 and a second operating system 121, which are different operating systems. For example, the first 111 or the second 121 operating systems may be operating systems generally used in mobile devices such as Android, iOS, Window 10 Mobile (Windows Phone), or operating systems generally used on personal laptop or desktop computers, for example Windows, Mac OS, Linux, and others; although it shall not be limited thereto.

That is, the cross-platform module 113 is compatible with the various operating systems and workable therein. Furthermore, although only the first 111 and the second 121 operating systems are specified in the present disclosure, it does not mean that the cross-platform module 113 is adapted to only two operating systems. Only two different operating systems are specified simply to demonstrate the operation of the cross-platform module 113 in different operating systems.

The cross-platform module 113 is installed in the first device 11 or the second device 12, which includes different operating systems. For example, the first device 11 or the second device 12 may be a smartphone, smartwatch, tablet, personal computer, or others, although it shall not be limited thereto. The cross-platform module 113 has to be written in different programing code, so that the cross-platform module 113 can be successfully installed and used in the different operating systems. Similarly, although only the first device 11 and the second device 12 are specified in the present disclosure, it does not mean that the cross-platform module 113 is only adapted to two devices. Only two devices are specified simply to demonstrate the operation of the cross-platform module 113 in different devices. Here, the first device 11 includes the first operating system 111 and the second device 12 includes the second operating system 121.

The first device 11 includes a first health management platform 112. This first health management platform 112 is the original health management platform disposed in the first device 11 which is adapted to the first operating system 111. The first health management platform 112 holds first health information 112a. Similarly, the second device 12 includes a second health management platform 122. This second health management platform 122 is the original health management platform disposed in the second device 12 which is adapted to the second operating system 121. The second health management platform 122 holds second health information 122a. Here, the first health management platform 112 and the second health management platform 122 correspond to systems such as Google Fit of Android, Apple Health of iOS, and others, although they shall be not limited thereto.

When the cross-platform module 113 is installed in the first device 11 and disposed in the first operating system 111, the cross-platform module 113 connects to the first health management platform 112, which is disposed in the first device 11, so as to transmit the first health information 112a from the first health management platform 112. That is to say, the user transmits the first health information 112a stored in the first health management platform 112 to the cross-platform module 113.

Similarly, when the cross-platform module 113 is installed in the second device 12 and disposed in the second operating system 121, the cross-platform module 113 connects to the second health management platform 122, which is disposed in the second device 12, so as to transmit the second health information 122a from the second health management platform 122. That is to say, the user transmits the second health information 122a stored in the second health management platform 122 to the cross-platform module 113.

Next, the cross-platform module 113 connects to the cloud server 13 to transmit the first health information 112a originally received from the first health management platform 112. The cloud server 13 then stores the first health information 112a. Here, the cross-platform module 113 and the cloud server 13 are interconnected through the internet, although the method of interconnection shall be not limited thereto. Wireless communication transmission or wireless internet is also other possible modes of interconnection. When the cross-platform module 113 is installed in the second device 12, the cross-platform module 113 connects to the cloud server 13 to transmit the second health information 122a received from the second health management platform 122. The cloud server 13 stores the received second health information 122a as well.

Thus, the cross-platform module 113 is adapted to both the first operating system 111 and the second operating system 121. It stores the first health information 112a of the first device 11 with the first operating system 111 and the second health information 122a of the second device 12 with the second operating system 121 in the cloud server 13. The health information of the different devices is stored in the same cloud server 13 through the cross-platform module 113. In addition, if the health information, adapted to different devices, can be stored in the cloud servers of these devices, the cross-platform health information management system 1 provided in the present disclosure can store this health information in the cloud server 13 of the cross-platform health information management system 1 to improve usability and management of the health information.

In addition, the cross-platform module 113 installed in the first device 11 can read the second health information stored in the cloud server 13, transform and adapt the second health information for use on the first health management platform 112, and then transmit it to the first health management platform 112.

For example, if the user first uses the second device 12 and uses the cross-platform module 113 disposed in the second device 12 to transmit the second health information to the cloud server 13, then when the user switches from using the second device 12 to using the first device 11 including the first operating system 111, the cross-platform module 113 disposed in the first device 11 can read the second health information stored in the cloud server 13. As the cross-platform module 113 can transform and adapt the second health information for use on the first health management platform 112 and then transmit it to the first health management platform 112, the user can still use the original health information on devices with different operating systems.

Despite not being mentioned so far, the cross-platform module 113 in the first device 11 can not only store the first health information in the cloud server 13, but can also read the first health information from the cloud server 13. If the first health information stored in the first device 11 is deleted accidently, the user can retrieve it from the cloud server 13 through the cross-platform module 113.

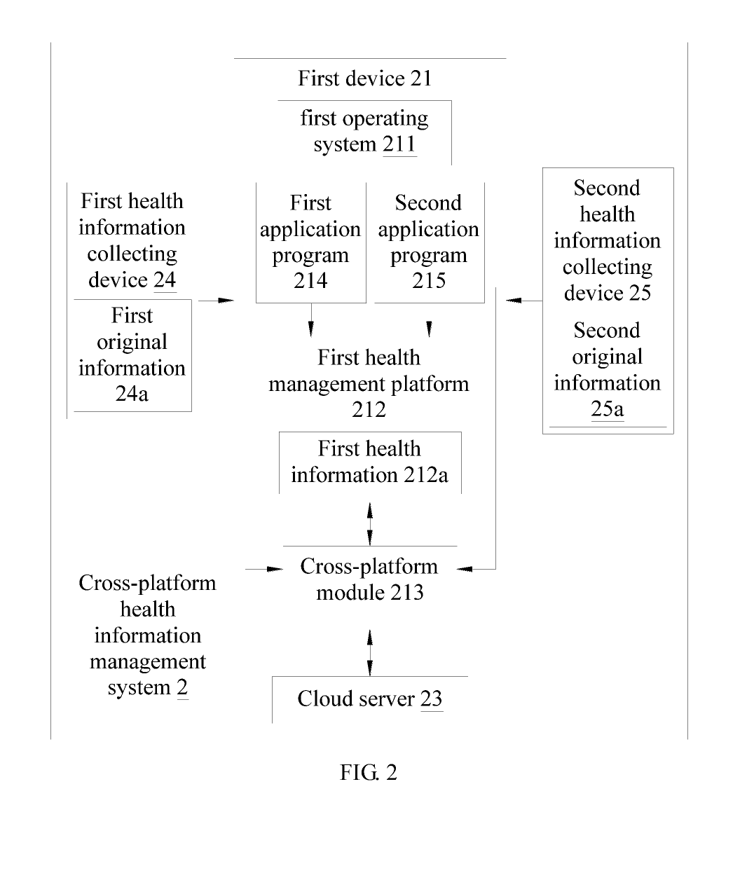

Please refer to FIG. 2, which is a block diagram of the second embodiment of a cross-platform health information management system in accordance with the present disclosure. As shown in the figure, the first device 21 is used as the exemplary embodiment of the cross-platform health information management system 2, and the second device has the same functions as mentioned above. Moreover, the operation and elements of the second device are the same as that described in the former embodiment, and so these details will not be repeated hereafter.

The first device 21 may include an application program. The exemplary embodiment of this application is a first application program 214 and a second application program 215. Here, a first health information collecting device 24 connects to the first application program 214 and a second health information collecting device 25 connects to the second application program 215. The connection may be realized through WiFi, infrared rays, Bluetooth, or other comparable ways, but the mode of connection shall not be limited thereto. Here, the first application program 214 and the second application program 215 are both adapted to the first operating system 211.

The first health information collecting device 24 and the second health information collecting device 25 may be of the current wearable health equipment or devices, such as a smartwatch, a smart bracelet; or exercise apparatus such as treadmills and exercise bikes which can record health information. The first health information collecting device 24 and the second health information collecting device 25 are different health information collecting devices. For example, different brands of wearable health equipment, smartwatches or exercise bikes which are capable of recording health information.

The first health information collecting device 24 can collect information about the walking or running step count, calories burnt, heart beat rate, blood pressure, and other health data. The first health information collection device 24 transmits this health information to the first application program 214 in the form of the first original information 24a. The second health information collecting device 25 functions in the same way as the first health information collecting device 24 to transmit the second original information 25a. Moreover, the first health management platform 212 is connected to the first application program 214 and the second application program 215, to receive and transform the first original information 24a and the second original information 25a into the first health information 212a. Besides, the first health management platform 212 connects to only one application program. For example, when only the application program 214 is connected, the received first original information 24a is transformed into the first health information 212a; or alternatively, the first health management platform 212 only connects to the second application program 215, and transforms the received second original information 25a into the first health information 212a. That is, the first health information 212a derived from the first health management platform 212 originates as information collected by the user with the first health information collecting device 24 or the second health information collecting device 25.

Although the first application program 214 and the second application program 215 are used as the exemplary embodiment, this does not mean the first device 21 includes only two application programs. What is meant is that multiple application programs can be connected to their corresponding health information collecting devices. The first device 21 is used as the exemplary embodiment, but the second device can include multiple application programs that connect to their corresponding health information collecting devices.

Next, the cross-platform module 213 disposed in the first device 21 connects to the first application program 214 and the second application program 215 to receive and transform the first original information 24a and the second original information 25a into the first health information 212a, and transmits the first health information 212a to the cloud server 23 to be stored. Similarly, the cross-platform module 213 connects to an application program as the first health management platform 212 does. For example, when only the first application program 214 is connected, the received first original information 24a is transformed into the first health information 212a, and same happens with the second application program. That is, apart from collecting the first health information 212a from the first health management platform 212, it can directly receive the first original information 24a and the second original information 25a, respectively derived from the first health information collecting device 24 and the second health information collecting device 25, through the first application program 214 and the second application program 215. After that, the received information is integrated into the first health information 212a. The user can choose the desired mode used by the cross-platform module 213.

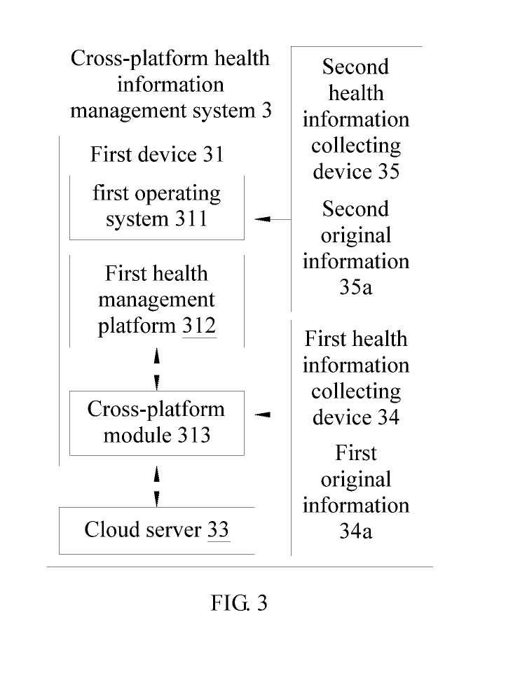

Please refer to FIG. 3, which is a block diagram of the third embodiment of a cross-platform health information management system in accordance with the present disclosure. As shown in the figure, the first device 31 is used as the exemplary embodiment of the cross-platform health information management system 3. Similarly, the second device has the same function as mentioned above, and so these details will not be repeated hereafter.

In the selected embodiment, the first device 31 also includes the first operating system 311, and the cross-platform module 313 connects to the first health management platform 312 so as to transmit the first health information. The first health information collecting device 34 produces the first original information 34a and directly connects to the cross-platform module 313 to transmit the first original information 34a to the cross-platform module 313. The cross-platform module 313 transforms the first original information 34a into the first health information.

Furthermore, the cross-platform module 313 is also connected to the second health information collecting device 35 and the second health information collecting device 35 transmits the second original information 35a to the cross-platform module 313. The cross-platform module 313 integrates the first original information 34a and the second original information 35a into the first health information. In other words, the cross-platform module 313 transforms the received original information (one, two or more pieces of information) into the first health information, and transmits it to be stored in the cloud server 33.

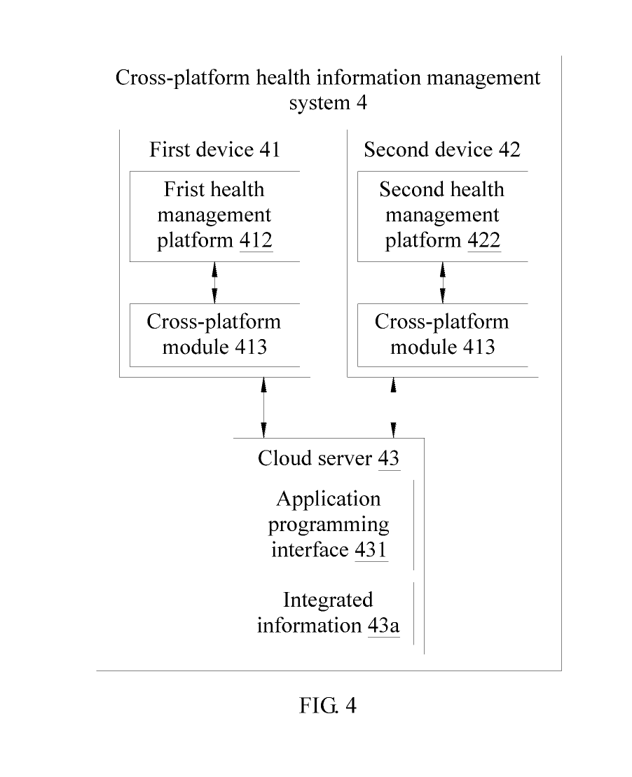

Please refer to FIG. 4, which is a block diagram of the fourth embodiment of a cross-platform health information management system in accordance with the present disclosure. As shown in the figure, the cross-platform health information management system 4 has the same functions as mentioned above. Moreover, the operation and elements thereof are the same as that described in the former embodiment, so these details will not be repeated hereafter.

The cloud server 43 integrates the first health information and the second health information into integrated information 43a, and then stores it in the cloud server 43. Next, the cross-platform module 431 installed in the first device 41 reads the integrated information 43a stored in the cloud server 43 and transmits the integrated information 43a to the first health management platform 412. Similarly, the cross-platform module 431 installed in the second device 42 also reads the integrated information 43a stored in the cloud server 43 and transmits the integrated information 43a to the second health management platform 422.

That is to say, when the first health information and the second health information are stored in the cloud server 43, the cloud server 43 integrates the two pieces of health information into the integrated information 43a. Consequently, when the health information is accidently deleted or the device is replaced, the user can retrieve the integrated information 43a stored in the cloud server 43 through the cross-platform module 431.

Furthermore, the cloud server 43 includes a defined application programming interface (API) 431. The API is the protocol designed for devices or application programs, so that different devices or application programs can be interconnected through the API. The cross-platform module 413 connects to the cloud server 43 according to the defined API 413 installed in the cloud server 43, so as to hereby transmit the first health information, the second health information or the integrated information 43a.

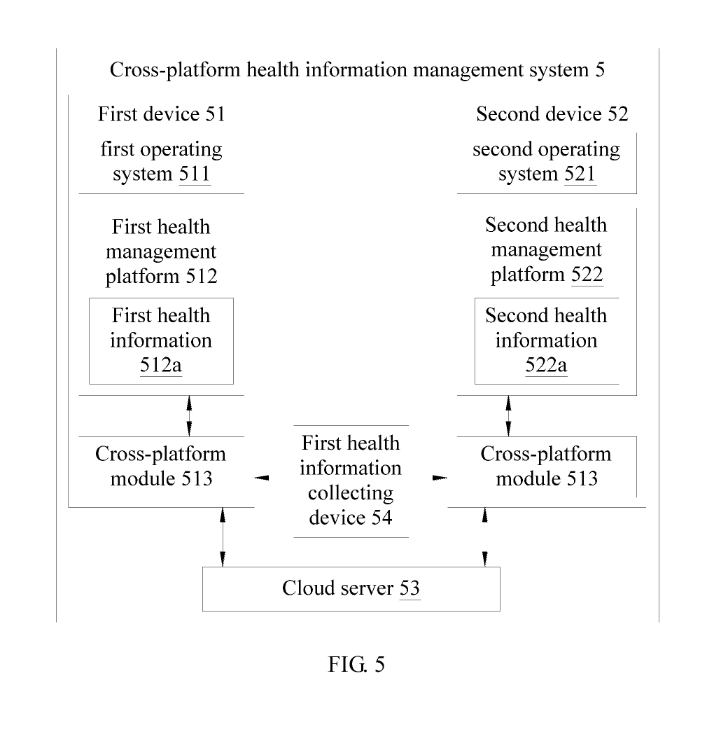

Please refer to FIG. 5, which is a block diagram of the fifth embodiment of a cross-platform health information management system in accordance with the present disclosure. As shown in the figure, the cross-platform health information management system 5 has the same functions as mentioned above. Moreover, the operation and elements thereof are the same as that described in the former embodiment, and so these details will not be repeated hereafter.

In the selected embodiment, the cross-platform health information management system 5 includes the first health information collecting device 54 which is connected to the first device 51 including the first operating system 511, and connects to the second device 52 including the second operating system 521. Here, the first operating system 511 and the second operating system 521 are different operating systems. The cross-platform module 513, adapted to function in the first operating system 511 and the second operating system 521 is provided by the first health information collecting device 54 and installed in either the first device 51 or the second device 52. Furthermore, the cross-platform module 513 connects to the first health management platform 512 or the second health management platform 522 and respectively transmits the first health information 512a or the second health information 522a. That is, when the first health information collecting device 54 connects to either the first device or the second device 52, the cross-platform module 513 is installed in either the first device 51 or the second device 52. In other words, in the selected embodiment, the cross-platform module 513 to be installed in either the first device 51 or the second device 52 is provided by the first health information collecting device 54 and thereby installed.

For example, when the user connects the first health information collecting device 54 to the chosen device such as the first device 51 or the second device 52, the user can decide whether or not to install the cross-platform module 513 in the device. The first health information collecting device 54 can determine whether the connected device includes the first operating system 511 or the second operating system 521, so that the cross-platform module 513 can be installed in the appropriate operating system. Thereby, the cross-platform module 513 can transmit information and store it in the cloud server using the device as mentioned previously.

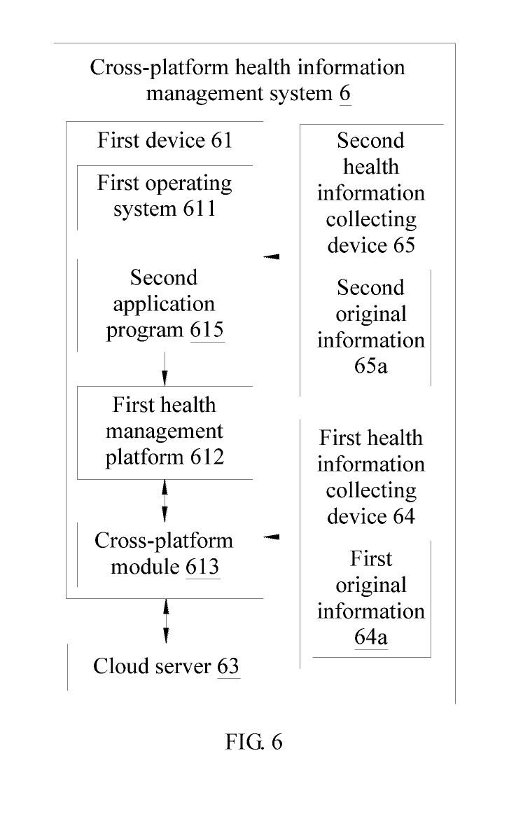

Please refer to FIG. 6, which is a block diagram of the sixth embodiment of a cross-platform health information management system in accordance with the present disclosure. As shown in the figure, the first device 61 is used as the exemplary embodiment of the cross-platform health information management system 6, and the second device 62 has the same functions as mentioned above. Furthermore, the operation and elements of the second device 62 are the same as that described in the former embodiment, and so these details will not be repeated hereafter.

In the selected embodiment, the first health information collecting device 64 is the same as mentioned above, and provides the cross-platform module 613 to be installed in the first device 61 and disposed in the first operating system 611. Furthermore, the cross-platform module 613 also connects to the first health management platform 612 and the cloud server 63, so as to transmit the health information between them. The first health information collecting device 64 produces the first original information 64a and connects to the cross-platform module 613 to transmit the first original information 64a to the cross-platform module 613. After that, the cross-platform module 613 transforms the first original information 64a into the first health information.

The first device 61 further includes the second application program 615. The second health information collecting device 65 connects to the second application program 615 and then transmits the second original information 65a to the second application program 615 as mentioned previously. Similarly, the second application program 615 connects to the first health management platform 612, and the first health management platform 612 receives the second original information 65a and transmits it into the first health information.

In other words, in practice, the cross-platform module 613 is provided by the first health information collecting device 64. That is that the cross-platform module 613 and the first health information collecting device 64 are made by the same manufacturer. The second health information collecting device 65 may differ from them. That is, the first original information 64a, derived from the first health information collecting device 64, is directly transmitted to the cross-platform module 613, and the second original information 65a, derived from the second health information collecting device 65, is transmitted to the second application program 615. After that, the second original information 65a is transmitted to the first health management platform 612.

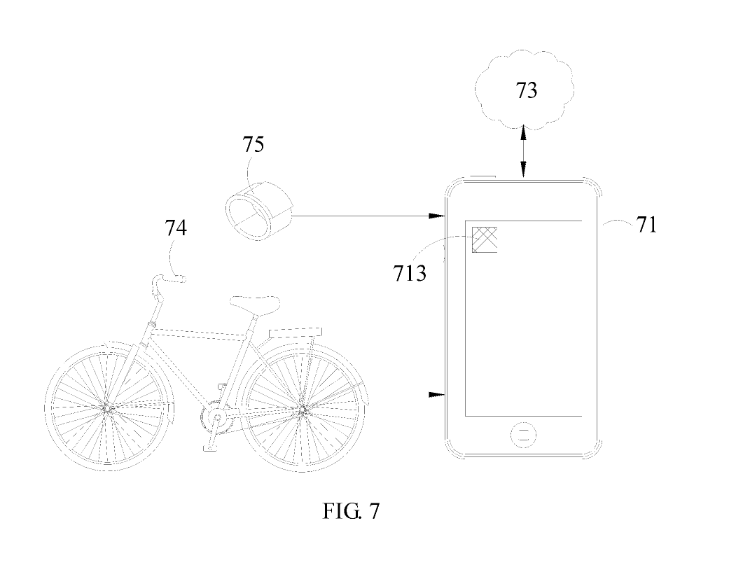

Please refer to FIG. 7, which is a schematic of a cross-platform health information management system in accordance with the present disclosure. As shown in the figure, in practice, the selected embodiments are applied to the present embodiment. For example, the first device is the Android smartphone (hereinafter referred to as Android phone 71). And, despite not being shown in FIG. 7, the second device is the iOS smartphone (hereinafter referred to as iOS phone). Then, the first health management platform is Google Fit, and the second health management platform is Apple Health, where both Google Fit and Apple Health hold and provide health information. The cross-platform module 713 is adapted to the corresponding mobile application programs of Android or iOS., The cross-platform module 713 can then be installed on the Android phone 71 and connect to Google Fit; or alternatively, the cross-platform module 713 can be installed on the iOS phone and connect to Apple Health. After that, the cross-platform module 713 can collect the health information from the corresponding operating system.

Moreover, the first health information collecting device may be the bike 74 designed with a recording function which can collect the riding distance and the number of calorie burnt. The second health information collecting device may be the smartwatch 75 which can collect the user's heart rate. The Android phone 71 is used as the exemplary embodiment. The original information collected by the bike 74 designed with a recording function (the first health information collecting device) and the smartwatch 75 (the second health information collecting device) is transmitted to the first application program or the second application program installed on the Android phone 71. Next, the original information is transmitted to Google Fit through the first application program or the second application program. The original information is then integrated as the health information. The cross-platform module 713 then collects and stores the obtained health information in the cloud server 73.

The cross-platform module 713 connects directly to the first application program and the second application program so as to receive the original information therefrom. Alternatively, the cross-platform module directly connects to the smartwatch 75 and the bike 74 designed with a recording function so as to receive the original information therefrom. The cross-platform module 713 transforms the obtained original information into the health information.

Furthermore, the cross-platform module 713 may be provided by the bike 74 designed with a recording function. That is, the bike 74, designed with recording function, connects to the Android phone 71 or the iOS phone to determine which kind of operating system is used, and then the cross-platform module 713 adapted to the corresponding operating system is installed in the phone.

Please refer to FIG. 1 again. As mentioned previously, the cross-platform module 113 can be installed in either the first device 11 or the second device 12. But the user shall also have the first device 11 and the second device 12 which have different operating systems. And the first health information 112a and the second health information 122a can both be transmitted to and stored in the cloud server 13. In addition, the cross-platform module 113 is adapted to different operating systems by using its conversion function. As shown in FIG. 4, the cloud server 43 also integrates the first health information and the second health information into the integrated information 43a. The integrated information 43a is then stored in the cloud server 43, so that the user can read the integrated information 43a by using the cross-platform module 413. Despite not being mentioned so far, all the functions, operations and technical features mentioned above are included.

In conclusion, through the use of the cross-platform module that is compatible with different operating systems, the cross-platform health information management system provided by the present disclosure can transmit to and store in the cloud server the health information derived from different devices with different operating systems. Besides, the health information adapted to a single operating system can be integrated as integrated information so as to be read by different devices with different operating systems.

The specific embodiments in the present disclosure have been described by reference to the drawings. However, numerous modifications and variations could be made thereto by those skilled in the art, without departing from the scope and spirit of the disclosure set forth in the claims. The modifications and variations should be in a range limited by the specification of the present disclosure.

What is claimed is:

1. A cross-platform health information management system, comprising:
a cross-platform module adapted to a first operating system and a second operating system which are different operating systems; the cross-platform module installed in a first device comprising the first operating system, and connected to a first health management platform disposed in the first device so as to transmit first health information; and alternatively, the cross-platform module installed in a second device comprising the second operating system, and connected to a second health management platform disposed in the second device so as to transmit second health information; and
a cloud server connected to the cross-platform module to transmit the first health information in the cross-platform module of the first device or to transmit the second health information in the cross-platform module of the second device, and storing the first health information or the second health information.

2. The cross-platform health information management system of claim 1, wherein the cross-platform module is connected to a health information collecting device, the health information collecting device transmits original information to the cross-platform module, and the cross-platform module transforms the original information into the first health information.

3. The cross-platform health information management system of claim 1, wherein the first device comprises an application program which is connected to a health information collecting device, the health information collecting device transmits the original information to the application program, and the first health management platform connects to the application program to receive and then transform the original information into the first health information.

4. The cross-platform health information management system of claim 1, wherein the cloud server integrates the first health information and the second health information into integrated information and then stores the integrated information, and the cross-platform module disposed in the first device reads the integrated information stored in the cloud server and then transmits the integrated information to the first health management platform.

5. The cross-platform health information management system of claim 1, wherein the cloud server comprises a defined application programming interface (API) configured to connect to the cross-platform module and to transmit the first health information or the second health information.

6. A cross-platform health information management system, comprising:
a first health information collecting device connected to a first device comprising a first operating system, or connected to a second device comprising a second operating system, wherein the first operating system and the second operating system are different operating systems;
a cross-platform module adapted to the first operating system and to the second operating system; the cross-platform module provided by the first health information collecting device, installed in the first device and connected to a first health management platform disposed in the first device so as to transmit first health information; and alternatively, the cross-platform module provided by the first health information collecting device, installed in the second device, and connected to a second health management platform disposed in the second device so as to transmit second health information; and
a cloud server connected to the cross-platform module to transmit the first health information in the cross-platform module of the first device or to transmit the second health information in the cross-platform module of the second device, and storing the first health information or the second health information.

7. The cross-platform health information management system of claim 6, wherein the first health information collecting device produces first original information and connects to the cross-platform module to transmit the first original information to the cross-platform module, and the cross-platform module transforms the first original information into the first health information.

8. The cross-platform health information management system of claim 6, wherein the first device comprises an application program which is connected to a second health information collecting device, the second health information collecting device transmits second original information to the application program, and the first health management platform connects to the application program to receive and then transform the second original information into the first health information.

9. A cross-platform health information management system, comprising:
a first device comprising a first operating system and a first health management platform, and the first health management platform having first health information;
a second device comprising a second operating system which is different from the first operating system and a second health management platform, and the second health management platform having second health information;
a cross-platform module installed in both the first device and the second device and adapted thereto; the cross-platform module connected to the first health management platform to transmit the first health information and connected to the second health management platform to transmit the second health information, and
a cloud server connected to the cross-platform module, and transmitting and storing the first health information and the second health information.

10. The cross-platform health information management system of claim 9, wherein the cloud server integrates the first health information and the second health information into integrated information and then stores the integrated information, and the cross-platform module disposed in the first device reads the integrated information stored in the cloud server and then transmits the integrated information to the first health management platform.
